(19) United States
(12) Patent Application Publication
(10) Pub. No.: US 2024/0297462 A1
(43) Pub. Date: Sep. 5, 2024

(54) SECURITY CONNECTOR FOR A SINGLE TWISTED PAIR OF CONDUCTORS

(71) Applicant: CommScope Technologies LLC, Hickory, NC (US)

(72) Inventors: Paul John PEPE, Clemmons, NC (US); Shawn Phillip TOBEY, Trinity, NC (US)

(73) Assignee: CommScope Technologies LLC, Hickory, NC (US)

(21) Appl. No.: 18/573,272

(22) PCT Filed: Jun. 24, 2022
(86) PCT No.: PCT/US2022/073162

§ 371 Date: Dec. 21, 2023

Related U.S. Application Data
(60) Provisional application No. 63/215,136, filed on Jun. 25, 2021.

(51) Int. Cl. H01R 13/645; H01R 13/46; H01R 13/506; H01R 13/6463; H01R 103/00

(52) U.S. Cl. CPC H01R 13/6456; H01R 13/465; H01R 13/506; H01R 13/6463; H01R 2103/00

(57) ABSTRACT

A keying scheme for single pair connectors provides the functionality needed to provide an institution with a level of security for private networks. The keying scheme relies upon three keying features to create at least seven different keying patterns, whose uniqueness can be additionally enhanced through color coding. The keying schemes for a single pair free connector include extensions that extend beyond a standardized forward face perimeter. Corresponding keying schemes are provided in mating receptacle connectors and couplers.

### RELATED APPLICATION

This application is being filed on Jun. 24, 2022 as a PCT International Patent Application and claims the benefit of U.S. Provisional Patent Application Ser. No. 63/215,136, filed on Jun. 25, 2021, the disclosure of which is incorporated herein by reference in its entirety.

### TECHNICAL FIELD

The present disclosure is directed to connectors and, more specifically, to security connectors for use with a single-twisted pair of conductors.

### BACKGROUND

A single twisted pair of conductors can be used to transmit data and/or power over a communications network that includes, for example, computers, servers, cameras, televisions, and other electronic devices including those on the internet of things (IoT), etc. In the past, this has been performed through use of Ethernet cables and connectors that typically include four pairs of conductors that are used to transmit four differential signals. Differential signaling techniques, where each signal is transmitted over a balanced pair of conductors, are used because differential signals may be affected less by external noise sources and internal noises sources such as crosstalk as compared to signals that are transmitted over unbalanced conductors.

In Ethernet cables, the insulated conductors of each differential pair are tightly twisted about each other to form four twisted pairs of conductors, and these four twisted pairs may be further twisted about each other in a so-called “core twist.” A separator may be provided that is used to separate (and hence reduce coupling between) at least one of the twisted pairs from at least one other of the twisted pairs. The four twisted pairs and any separator may be enclosed in a protective jacket. Ethernet cables are connectorized with Ethernet connectors; a single Ethernet connector is configured to accommodate all four twisted pairs of conductors. However, it is possible that data and/or power transfer can be effectively supported through a singled twisted pair of conductors with its own more compact connector and cable. Couplers that can enable electrical coupling of connectors, with each connector coupled to a single pair of electrical conductors, are an important element in broadening the use of data and/or power transfer over a single pair of electrical conductors. The ability to segregate and secure one network from another to help limit access and/or maintain control over data can be particularly useful in certain applications, e.g., military or government networks, financial institutions, research laboratories, etc.

### SUMMARY

A keying scheme for single pair connectors provides the functionality needed to provide an institution with a level of security for private networks. The keying scheme relies upon three keying features to create at least seven different keying patterns, whose uniqueness can be additionally enhanced through color coding. The keying schemes for a single pair free connector include extensions that extend beyond a standardized forward face perimeter. Corresponding keying schemes are provided in mating receptacle connectors and couplers.

In certain aspects, the present disclosure is directed to a security connector that includes a free connector housing exactly two contacts that conduct power and/or data. The free connector has a forward face with a standardized perimeter and at least one keying extension extending outward from the standardized perimeter.

In certain aspects, the security connector includes up to three different keying extensions that extend outward from the standardized perimeter. In certain aspects, the up to three different keying extensions provide at least seven different keying combinations. In certain aspects, the free connector additionally includes a color-coded security feature. In certain aspects, the up to three different keying extensions comprise at least one of a downward extension and a side extension.

In certain aspects, the present disclosure is directed to a coupler. The coupler includes a dual-ended coupler body housing a contact sub-assembly having exactly two electrical contacts that transmit power and/or data. At least one end of the dual-ended coupler body includes at least one keying recess that corresponds to the at least one keying extension of the security connector enabling the coupler to interface with the security connector.

In certain aspects, the present disclosure is directed to a fixed connector. The fixed connector includes a fixed connector body that houses exactly two electrical contacts that transmit both power data. The fixed connector body includes an opening for receiving the security connector. The opening of the fixed connector body includes at least one keying recess corresponding to the at least one keying extension of the security connector.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE FIGURES

FIGS. 1A-1B illustrate example embodiments of cables having single twisted pairs of conductors.

FIGS. 2A-2D illustrate an example embodiment of a free connector for a single pair of electrical conductors including an assembled view, an exploded assembly view, a cross section of a forward connector body of the connector and a pair of electrical contacts of the connector, respectively.

FIGS. 3A-3C illustrate an example embodiment of a fixed connector, which is configured to mate with the free connector of FIGS. 2A-2D, including an assembled perspective view, a front view and a pair of electrical contacts of the fixed connector, respectively.

FIGS. 4A-4D illustrate an example embodiment of a shielded coupler including an assembled perspective, an exploded assembly perspective, a side cross-sectional, and a top cross-sectional view of the coupler, respectively.

FIGS. 5A-5B provide perspective views of a pair of the connectors of FIGS. 2A-2D before and after electrical coupling with the coupler of FIGS. 4A-4D while FIGS. 5C and 5D provide perspective views of three-way and four-way couplers, respectively.

FIG. 6 is an exploded perspective view of a free connector.

FIGS. 7A-7B comprise a first side perspective of the free connector of FIG. 6 and a first side perspective of the free connector of FIG. 6 with a metal frame separated from a coupled forward connector body and rear connector body, respectively.

FIGS. 8A-8B comprise a second side perspective of the free connector of FIG. 6 and a second side perspective of the free connector of FIG. 6 with a metal frame separated from a coupled forward connector body and rear connector body, respectively.

FIGS. 9A-9B comprise a lower face perspective of the free connector of FIG. 6 and the lower face perspective with a metal frame removed from the free connector, respectively.

FIG. 10 comprises an upper perspective view of a metal frame of the free connector of FIG. 6.

FIGS. 11A-11B comprise upper and lower perspective views of the rear connector body of the free connector of FIG. 6.

FIGS. 12A-12B comprises left and right perspective views of the rear connector body of the free connector of FIG. 6.

FIG. 13 presents Table 1 which showing seven combinations of key type, key color, and key features of modified versions of the free connector of FIG. 6 and the coupler shown in FIG. 13A.

FIG. 13A provides a front view of a fixed connector or coupler indicating keying features referenced in Table 1 of FIG. 13.

FIG. 13B provides a front view of a free connector indicating keying features corresponding to the connector of FIG. 13A and referenced in Table 1 of FIG. 13.

FIG. 13C provides a front view of the free connector of FIG. 13B with a standardized outer perimeter defined by the free connector of FIG. 6 overlayed thereupon.

FIGS. 14A-14B respectively provide forward and side perspective views of a free connector having a first keying scheme.

FIGS. 14C-14D respectively provide forward and side perspective views of a free connector having a second keying scheme.

FIGS. 14E-14F respectively provide forward and side perspective views of a free connector having a third keying scheme.

FIGS. 14G-14H respectively provide forward and side perspective views of a free connector having a fourth keying scheme.

FIGS. 15A-15B respectively provide a forward and side perspective view of a fixed connector/coupler having a first keying scheme corresponding to free connector of FIGS. 14A-14B.

FIGS. 15C-15D respectively provide a forward and side perspective view of a fixed connector/coupler having a first keying scheme corresponding to free connector of FIGS. 14C-14D.

FIGS. 15E-15F respectively provide a forward and side perspective view of a fixed connector/coupler having a first keying scheme corresponding to free connector of FIGS. 14E-14F.

FIGS. 15G-15H respectively provide a forward and side perspective view of a fixed connector/coupler having a first keying scheme corresponding to free connector of FIGS. 14G-14H.

FIGS. 16A-16E comprise various views of a keyed free connector.

FIGS. 17A-17C comprise various views of a keyed fixed connector/coupler.

### DETAILED DESCRIPTION

A keying scheme for single pair connectors provides the functionality needed to provide an institution with a level of security for private networks. The keying scheme relies upon three keying features to create at least seven different keying patterns, whose uniqueness can be additionally enhanced through color coding. The keying schemes for a single pair free connector include extensions that extend beyond a standardized forward face perimeter. Corresponding keying schemes are provided in mating receptacle connectors and couplers.

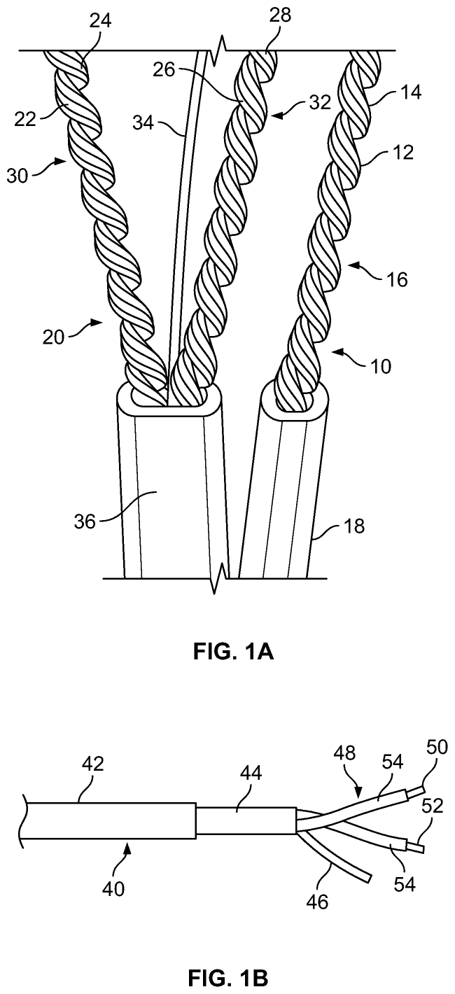

FIG. 1A illustrates two example embodiments of cables containing one or more single twisted pairs of conductors capable of transmitting electricity, data, or both electricity and data. A first cable 10 includes first and second conductors 12, 14 that are twisted together to form a single twisted pair 16. The conductors 12, 14 are enclosed by a protective jacket 18. A second cable 20 includes first through fourth conductors 22, 24, 26, 28. Conductors 22 and 24 are twisted together to form a first single twisted pair 30, and conductors 26 and 28 are twisted together to form a second single twisted pair 32. The twisted pairs 30 and 32 are separated by a separator 34, and are encased in a protective jacket 36. In certain example embodiments, the cables 10, 20 include a number of twisted pairs greater than two. In some examples, each single twisted pair of conductors is configured for power transmission. In some examples, each single twisted pair of conductors is configured for data transmission. In certain example embodiments, each single twisted pair of conductors, e.g., 16, 30, 32, is configured for both power and data transmission, e.g., data transmission up to 600 MHZ (ffs) and a current carrying capacity up to 1 A (amp). Each single twisted pair of conductors, e.g., 16, 30, 32, can be connectorized with the various embodiments or combination of embodiments of free connectors and fixed connectors as described herein. FIG. 1B is an example of a shielded in cable 40. The shielded cable 40 includes an outer jacket 42, a foil shield 44, a drain wire 46, and a single twisted pair 48 of conductors 50 and 52: each of the conductors 50 and 52 is provided with insulation 54.

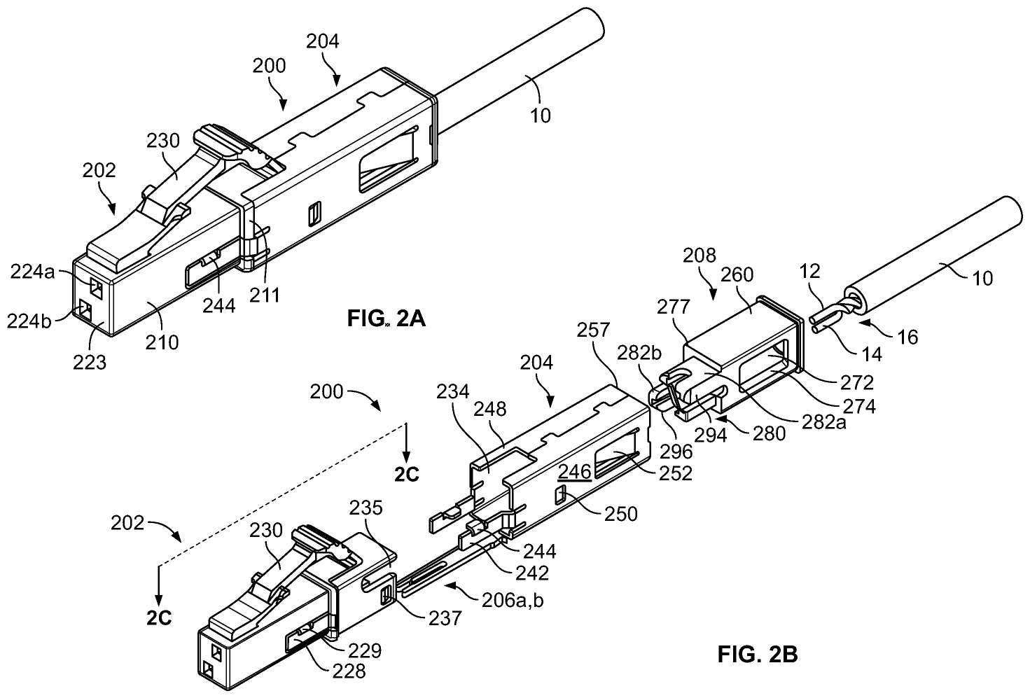

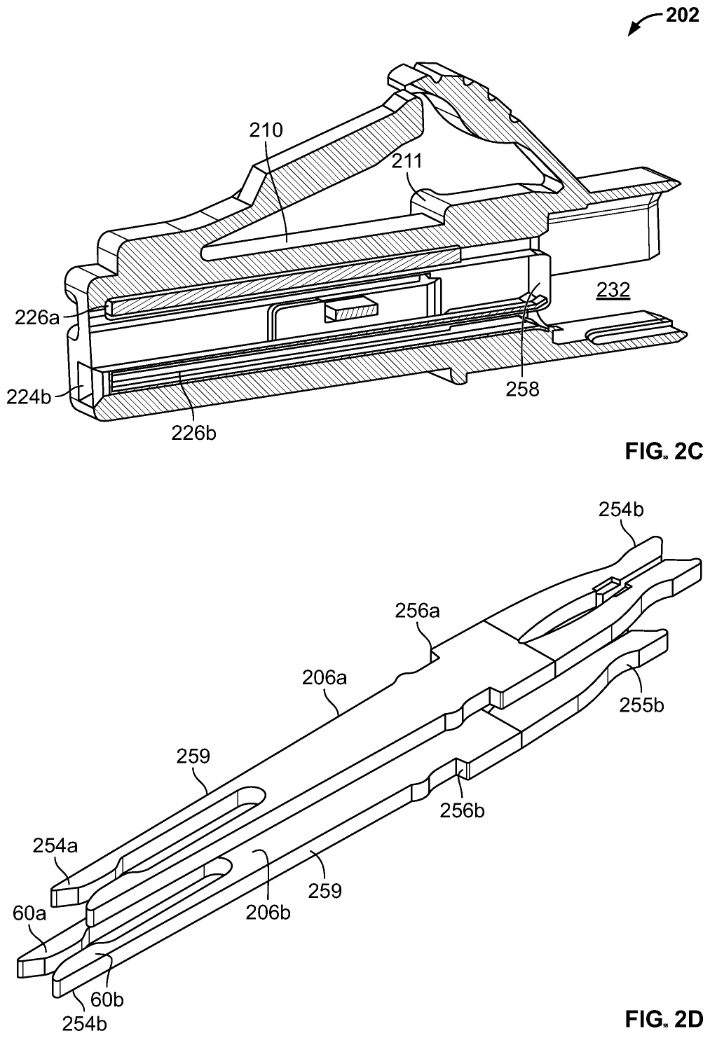

Referring to FIGS. 2A-2D an example embodiment of a free connector 200 for a single twisted pair of electrical conductors is illustrated. The free connector 200 includes a forward connector body 202, a metal frame 204, a pair of electrical contacts 206a, 206b, and a rear connector body 208. The free connector 200 can be coupled to a single twisted pair of conductors, e.g., conductors 12 and 14 of the single twisted pair 16 of cable 10.

The forward connector body 202 includes an elongate forward portion 210 and a rear receiving portion that is separated by a shoulder 211.

The elongate forward portion 210 of the forward connector body 202 includes a forward face 223 having a pair of offset openings 224a, 224b corresponding to contact receiving channels 226a, 226b: the openings 224a, 224b receive pin contacts that electrically interface with the electrical contacts 206a, 206b. In certain embodiments, a recess 228 is provided on each side face of the elongate forward portion 210 to interface with and retain the metal frame 204. Each recess 228 includes a recessed notch 229 to receive an interfacing tab 244 of the metal frame 204 to further ensure that the metal frame 204 remains secured to the forward connector body 202. The forward connector body 202 also includes a cantilevered latch 230.

The rear receiving portion 212 of the forward connector body 202 is unitary (e.g., molded as a single unit) with the elongate forward portion 210 of the forward connector body 202. The rear receiving portion 212 defines a central cavity 232 that provides rear access to the contact receiving channels 226a, 226b of the elongate forward portion 210. Each side face of the rear receiving portion 212 includes a slot 235 to interface with the rear connector body 208 and an outward extending tab 237 to interface with the metal frame 204.

The metal frame 204 of the free connector 200 comprises a metal shell body having a central cavity 234 that is slidable over the rear receiving portion 212 of the forward connector body 202. The metal frame 204 is held in place about the rear receiving portion 212 through use of a pair of flex tabs 242 that interface with corresponding recesses 228 of the forward connector body 202. Each of the flex tabs 242 includes in inward facing tab 244 to interface with recessed notch 229 of the forward connector body 202. Each side face 246, 248 of the metal frame 204 includes an opening 250 to interface with outward extending tab 237 of the forward connector body 202. Each point of interface between the metal frame 204 and the forward connector body 202 assists in securing the metal frame 204 to the forward connector body 202. Each side face 246, 248 of the metal frame 204 is additionally equipped with an inward directed beam 252 (e.g., shield beam) to establish an electrical interface with a cable shield (foil or drain wire) of the cable carrying the single pair of conductors (e.g., see FIG. 1B). Note that, while the metal frame 204 includes a shield beam for interfacing with a shield of a shielded cable, the metal frame 204 can also be utilized in conjunction with a non-shielded cable. In the instance of a non-shielded cable, the metal frame provides additional structural support to the connector 200. In certain non-shielded uses, the frame 204 is alternatively made of a non-metal material, e.g., plastic.

Electrical contacts 206a, 206b each include a forward portion having a tuning fork receptacle contact 254a, 254b while a rear portion of each of the electrical contacts 206a, 206b includes an insulation displacement contact (IDC) 255b. Each tuning fork receptacle contact 254a, 254b includes a pair of opposing spring arms 60a, 60b presenting an angled opening to receive a pin contact. Each of the electrical contacts 206a, 206b includes a shoulder 256a, 256b that interfaces with a stop 258 (see FIG. 2C) within the elongate forward portion 210 of the forward connector body 202. The electrical contacts 206a, 206b include one or more tangs 259 to help retain each of the tuning fork receptacle contacts 254a, 254b within their respective contact receiving channels 226a, 226b of the forward connector body 202.

The rear connector body 208 of the free connector 200 includes a rear body portion 260 that defines a central cavity 272 into which is inserted a pair of conductors (e.g., conductors 12, 14). Each side face is provided with an elongate opening 274 into which the inward directed beams 252 of the metal frame 204 extend, wherein an electrical interface with the foil (or drain wire) of a conductor within the cavity 272 is established. A latch (now shown) on a lower face of the rear body portion 260 interfaces with a cut-out (not shown) of the metal frame 204 to secure the rear connector body 208 to the metal frame 204. A lip edge 277 of the rear body portion 260 seats against a rear face 257 of the metal frame 204.

The rear connector body 208 of the free connector 200 includes a contact receiving portion 280 that extends forward from the rear body portion 260. The contact receiving portion 280 is essentially divided into a first half 282a to accommodate the upper positioned electrical contact 206a and a second half 282b to accommodate the lower positioned electrical contact 206b. The first half 282a of the contact receiving portion 280 includes an upward channel that is contoured to direct the end of a conductor upward (e.g., a 90 degree bend) to extend through a contact receiving slot. The second half 282b of the contact receiving portion 280 includes a downward channel that is contoured to direct the end of a conductor downward (e.g., a 90 degree bend) to extend through a contact receiving slot.

The IDC contacts 255a, 255b of the electrical contacts 206a, 206b are inserted into their respective contact receiving slots to establish an electrical interface with the conductor extending therethrough. Each of the IDC contacts 255a, 255b applies a normal force to the respective conductor and cuts through both the insulation of the conductor and a portion of the conductor itself to create the electrical interface. Note that the electrical interface is established without requiring crimping of the conductor to the electrical contact, i.e., the electrical interface is crimp-less. The upward channel is, in part, defined by an upper outward extending arm 294 while the downward channel is, in part, defined by a lower outward extending arm 296. Each of upper outward extending arm 294 and lower outward extending arm 296 interface with respective corresponding slots 235 of the forward connector body 202 when the free connector 200 is assembled to assist in aligning and stabilizing the rear connector body 208 relative to the forward connector body 202.

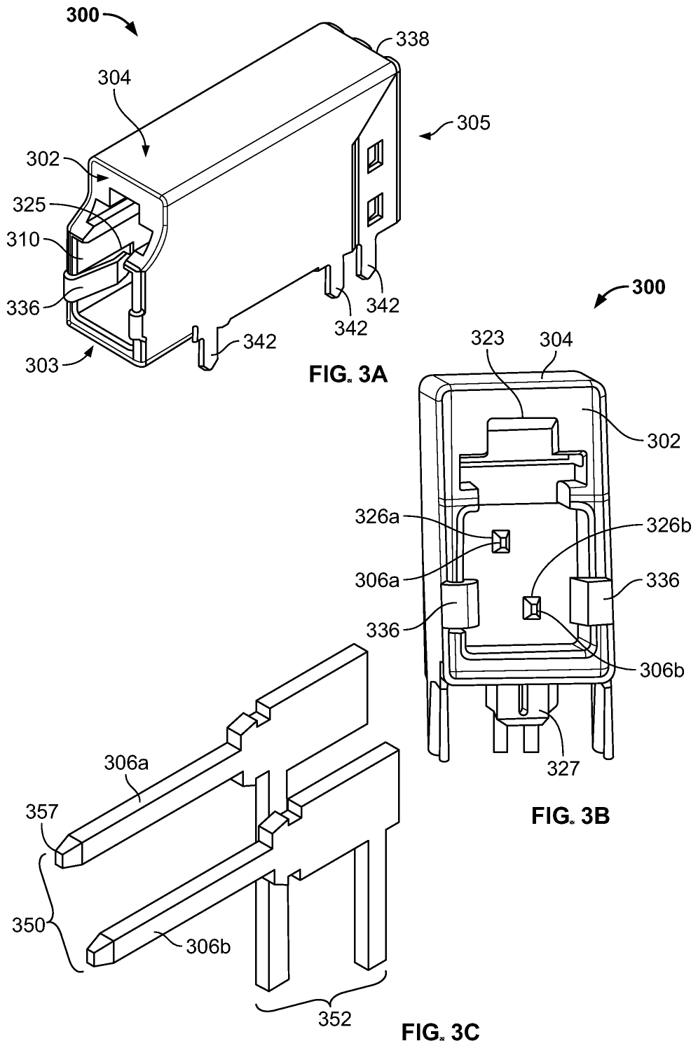

An example of a fixed connector 300, suitable to mate with free connector 200 is illustrated in FIGS. 3A-3C. The fixed connector 300 generally includes a housing body 302, a metal frame 304, and a pair of pin contacts 306a, 306b (straight or bent for board mounting). A forward end 303 and a rearward end 305 further define the fixed connector 300.

The housing body 302 of the fixed connector 300 includes a forward central channel 310 that receives the free connector 200. A notch 323 is provided within the housing body 302 to interface with the cantilevered latch 230 of the free connector 200. Further, side recesses 325 in each side face serve as an interface element for the metal frame 304. A mounting pin 327 extends from the housing body 302 and through the metal frame 304 for circuit board mounting of the connector 300. The housing body further includes openings 326a, 326b to channels (not shown) into which the pin contacts 306a, 306b are inserted: when fully inserted, the pin contacts 306a, 306b extend into the forward central channel 310.

The metal frame 304 of the fixed connector 300 is a metal shell defining a central cavity that is slidable over the housing body 302. The metal frame 304 is held in place about the housing body 302 through use of a pair of clips 336 that interface with the side recesses 325. In certain embodiments, a back face 338 of the metal frame is enclosed with a back panel 340 while in other embodiments the back face 338 is left open. Further, in certain embodiments, the metal frame 304 is provide with one or more shield pins 342 that are insertable in an application where the fixed connector 300 is board mounted.

Each of the pin contacts 306a, 306b of the fixed connector 300 include a forward portion 350 and a rear portion 352 that can be electrically coupled to a conductor, e.g., conductor 10, in any suitable manner. The forward portion 350 includes tapered faces that form a four-sided pyramid shape with a flattened apex 357: the flattened apex 357 having a rectangular or square cross-section.

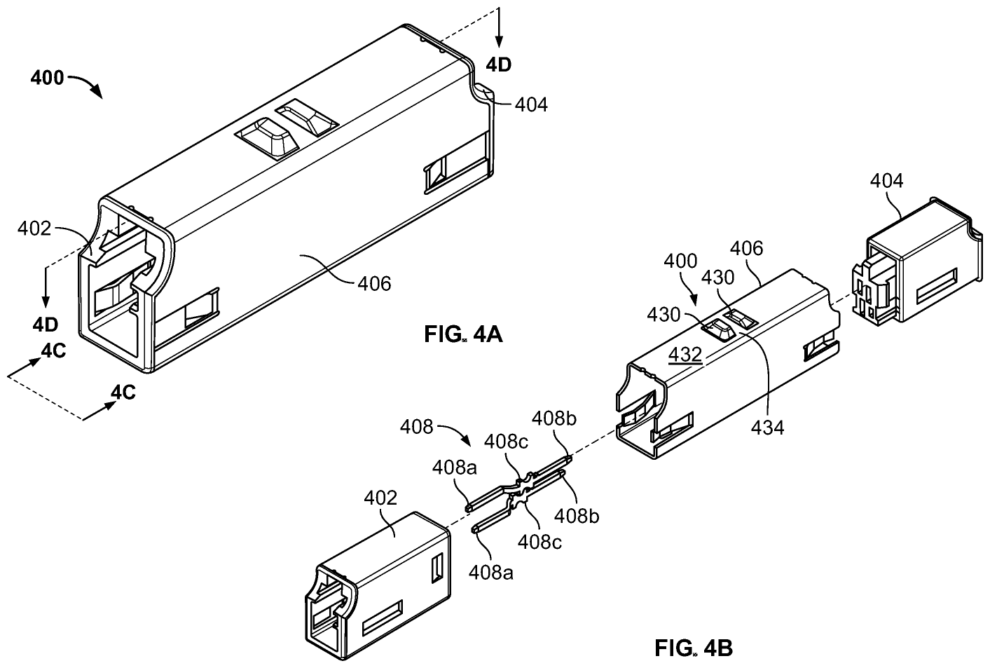

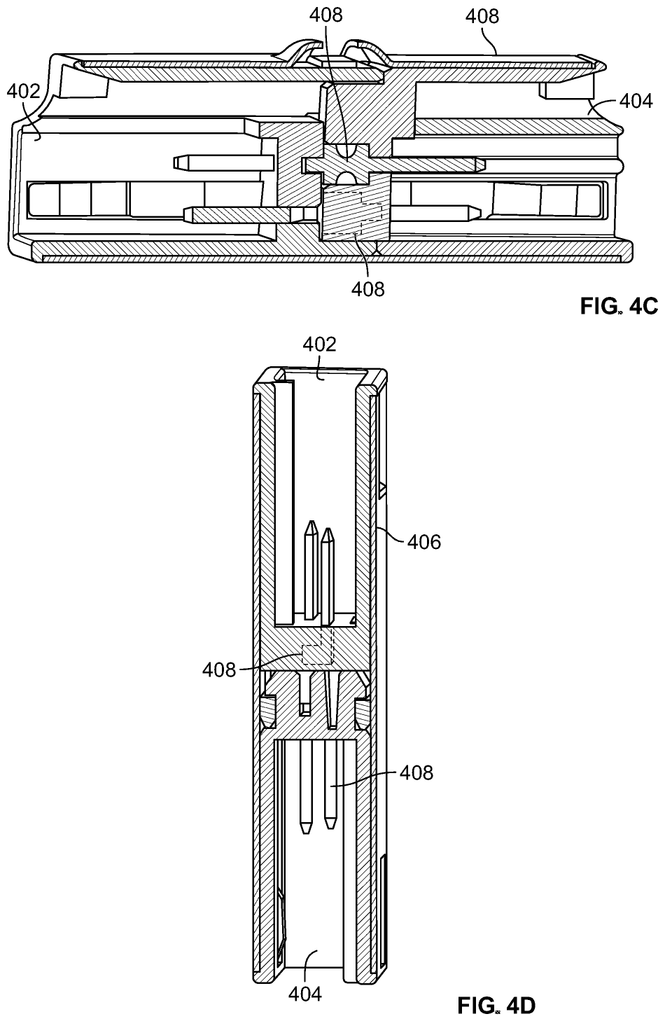

Referring to FIGS. 4A-4B an example embodiment of a coupler 400 is illustrated. As shown, the coupler 400 includes a first housing 402, a second housing 404, a metal shield 406, and a pair of contacts 408, each having a forward contact 408a and a rearward contact 408b separated by a central portion 408c. The first housing and second housing 402, 404 securely interface with one other to centrally support the first pair of contacts 408 enabling the first ends 408a of the contacts 408 to extend towards a first end 412 of the coupler 400 and the second ends 408b of the coupler 400 to extend towards a second end 414 of the coupler. FIGS. 4C and 4D provide cross-sectional views of the assembled coupler, including the metal shield 406, taken along lines 4C-4C and 4D-4D, respectively, of FIG. 4A, with each illustrating the placement of the first housing 402, the second housing 404, the metal shield 406, and the pair of contacts 408.

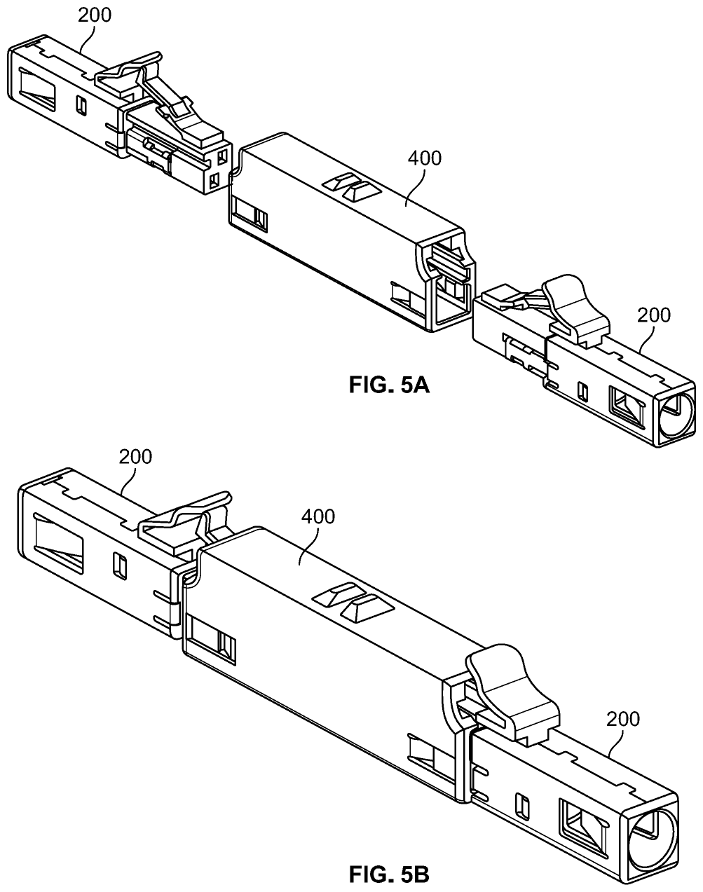

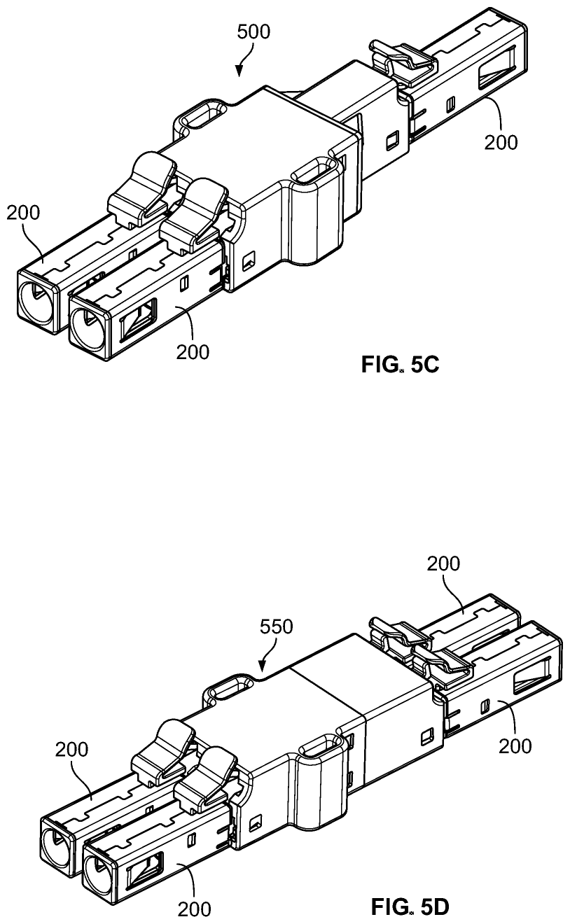

FIGS. 5A and 5B illustrate the assembled coupler 400 with two of the free connectors 200 ready to be received by the coupler 400 and with the two connectors 200 removably received within the coupler 400 and electrically coupled, respectively. Each of the couplers 400 includes a pair of opposing projections 430 projecting away from a top face 432 of the coupler 400: the projections 430 define a channel 434. The projections 430 and channel 434 are used to position the coupler 400 in a high density panel further described herein. Other coupler designs for coupling a pair of connectors, with each of the connectors coupled to exactly two electrical conductors, are also possible.

FIGS. 5C-5D illustrate a three-way coupler 500 and a four-way coupler 550 that can be used in conjunction with multiple free connectors 200. Further details on three-way couplers and four-way couplers can be found in PCT publication number WO2021/252938 and entitled “Single Pair Ethernet Multi-Way Couplers,” which is hereby incorporated by reference. Any of the couplers, free connectors and/or fixed connectors described herein can be enhanced with the keying features described herein.

Further details regarding free connectors, fixed connectors and couplers can be found in PCT publications WO 2018/200528: WO 2019/165466; WO 2020/190758; and WO2021/067274. The identified PCT publications and applications are hereby incorporated by reference.

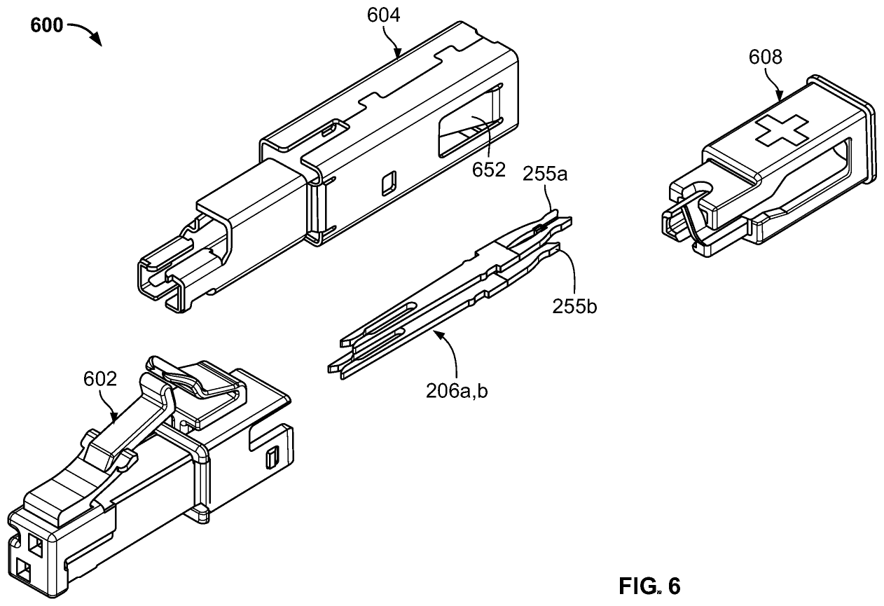

FIG. 6 illustrates another example embodiment of a free connector 600. The free connector 600 includes a forward connector body 602, a metal frame 604, the pair of electrical contacts 206a, 206b, which are also shown in use with free connector 200, and a rear connector body 608.

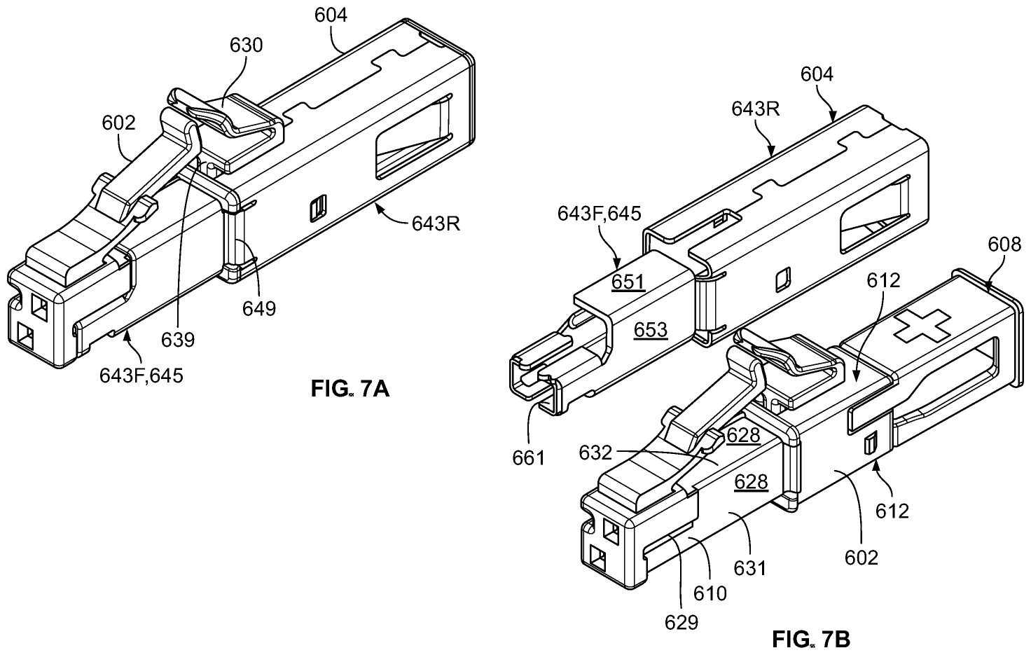

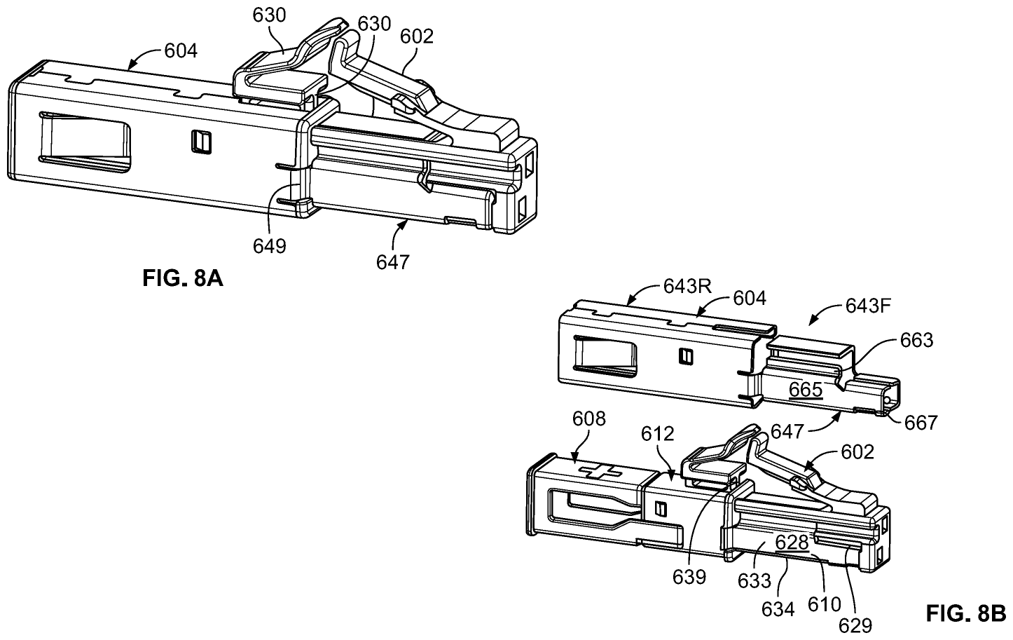

The forward connector body 602 generally corresponds to the forward connector body 202 of the free connector 200 while the metal frame generally corresponds to the metal frame 204 of the free connector 200. However, modifications made to the forward connector body 202, now evident in forward connector body 602, and modifications made to the metal frame 204, now evident in metal frame 604 can be appreciated with respect to FIGS. 7A-7B, 8A-8B, 9A-9B, and 10.

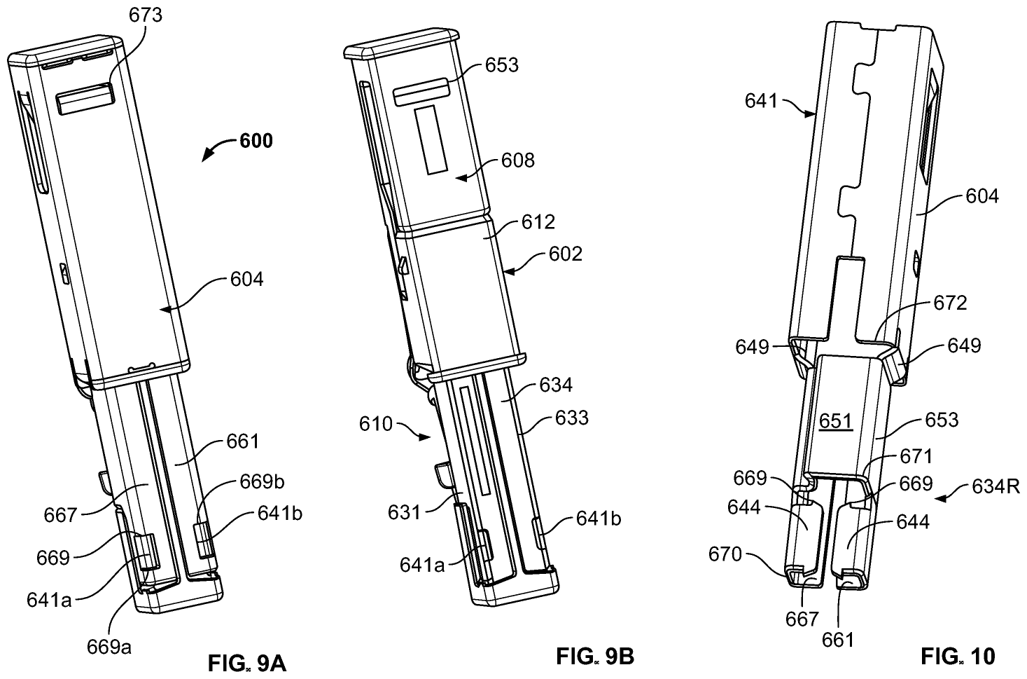

As shown, the forward connector body 602 of connector 600 includes an elongate forward portion 610 having a first side 631 and a second side 633 connected by an upper face 632 and a lower face 634 where each of the sides 631, 633 and faces 632, 634 includes a recessed portion 628 to accommodate a more expansive metal frame 604 that now covers a greater portion of each of the sides 631, 633 as well as now covering a portion of both the upper and lower faces 632, 634: the more expansive metal frame 604 provides improved coupling attenuation over metal frame 204. Further, the elongate forward portion 610 of the forward connector body 602 is provided with a recessed notch 629 on each of the first and second sides 631, 633 enabling an interface with the metal frame 604. A rear portion of a cantilevered latch 630, located on a rear receiving portion 612 of the forward connector body 602, is provided with a narrow t-shaped mount 639 enabling the expanded metal frame 604 to lie proximate the t-shaped mount 639 as well as lie beneath the rear portion of the cantilevered latch 630. Referring to FIGS. 9A-9B, the elongate forward portion 610 further includes projections 641a, 641b extending from respective first and second sides 631, 633 to lower face 634 that further serve to interface with the metal frame 604 and assist in retaining the metal frame 604 in place relative to the forward connector body 602.

The metal frame 604, similar to metal frame 204, includes a rear portion 643R positioned about the rear connector body 608 of the connector 600 and about the rear receiving portion 612 of the forward connector body 602 of the connector 600. The metal frame 604 additionally includes a forward portion 643F that is unitary with the rear portion 643R. The forward portion 643F, positioned about the elongate forward portion 610 of the forward connector body 602, includes a cantilevered first side arm 645 and a cantilevered second side arm 647 each of which is coupled to the rear portion 643R of the metal frame 604 by a flexible hinge 649 allowing the first and second side portions 645, 647 to flex inward/outward as needed during assembly of the free connector 600. In certain embodiments, the forward portion 643F of the metal frame 604 comprises a component distinct from the rear portion 643R, e.g., the metal frame 604 comprises two or more discrete pieces.

The first side arm 645 of the metal frame 604 includes an upper face 651 that transitions to a first side 653 and to a first lower face 661. The second side arm 647 of the metal frame 605 includes a recessed side, conformed to a keying notch, that transitions to a second side 665 and a second lower face 667. Each of the first side arm 645 and the second side arm 647 includes a cut-out 669a, 669b to interface with projections 641a, 641b of the forward connector body 602. Each of the first side arm 645 and the second side arm 647 of the metal frame 604 additionally includes an interfacing tab 644 to interface with a corresponding recessed notch 629 of the forward connector body 602. The interfacing tabs 644 include edge tangs 669 to assist in retaining the interfacing tabs 644 within the respective recessed notches 629. Most, or all, of the forward-facing edges of the metal frame 605, such as edges 670, 671, 672, are beveled as an anti-snag feature to enable smooth insertion of the free connector 600 into a fixed connector.

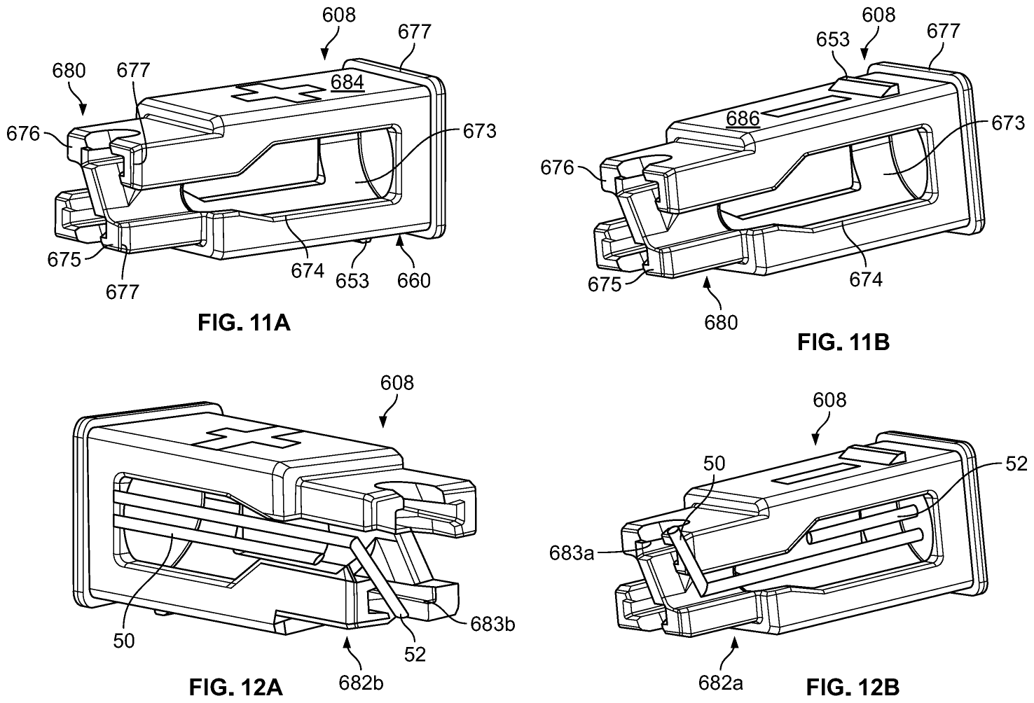

The rear connector body 608 of the free connector 600 generally corresponds to the rear connector body 208 of the free connector 200. However, modifications made to the rear connector body 208, now evident in rear connector body 602, can be appreciated with respect to FIGS. 11A-11B and 12A-12B.

As shown, the rear connector body 608 of the free connector 600 includes a rear body portion 660 that defines a central cavity into which is inserted a pair of conductors. Each side face is provided with an elongate opening 674, which extends through a front face 675 of the rear connector body 608, into which inward directed beams 652 (see FIG. 6) of the metal frame 604 extend, wherein an electrical interface with a foil (or drain wire) of a conductor within the cavity is established. The elongate opening 674, being extended through the front face 675, provides an open access to any conductor inserted within the cavity 673. A latch on a lower face 686 of the rear body portion 660 interfaces with a cut-out 673 (see FIG. 9A) of the metal frame 604 to secure the rear connector body 608 to the metal frame 604. A lip edge 677 of the rear body portion 660 seats against a rear face of the metal frame 604. The front face 675 of the rear connector body 608 presents a flat front surface 676, to seat flush against the forward connector body 602, and beveled edges to ease sliding the rear connector body 608 relative to the forward connector body 602.

The rear connector body 608 of the free connector 600 includes a contact receiving portion 680 that extends forward from the rear body portion 660. The contact receiving portion 680 is essentially divided into a first half 682a to accommodate the upper positioned electrical contact 606a and a second half 682b to accommodate a lower positioned electrical contact 606b. The first half 682a of the contact receiving portion 680 includes an upward channel that is contoured to direct the end of a conductor upward (e.g., a 90 degree bend) to extend across a contact receiving slot 683a, see FIG. 12B with conductor 50. The second half 682b of the contact receiving portion 680 includes a downward channel that is contoured to direct the end of a conductor downward (e.g., a 90 degree bend) to extend through a contact receiving slot 683b, see FIG. 12A, with conductor 52. In certain embodiments, an upper face 684 of the rear connector body 608 is marked with a plus sign, e.g., “+”, to indicate a positive terminal relative to the upward channel while the lower face 686 of the rear connector body 608 is marked with a minus sign, e.g., “−”, to indicate a negative terminal relative to the downward channel.

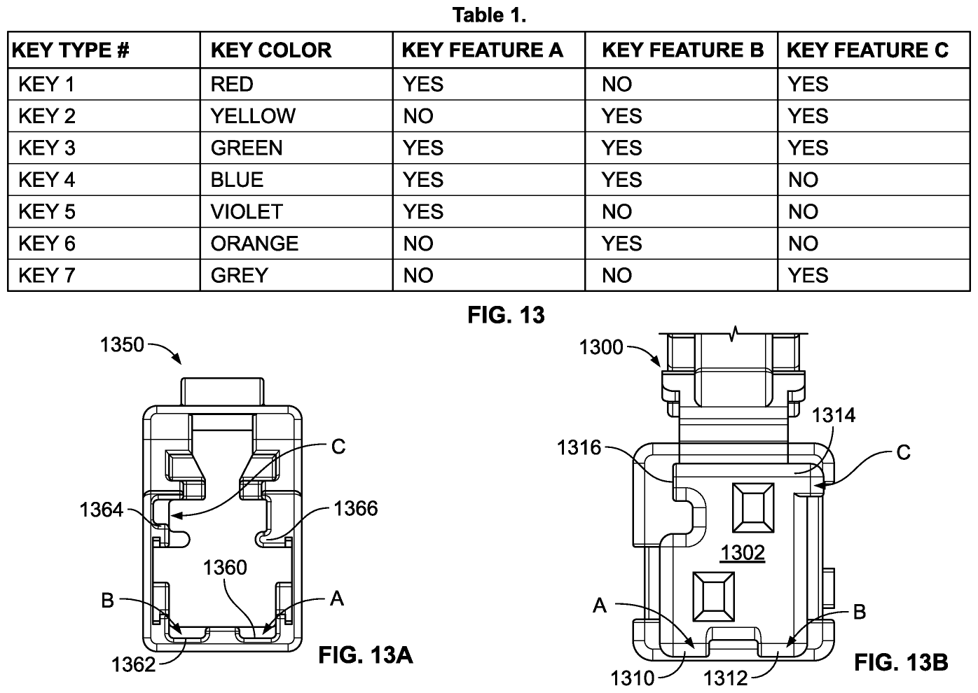

According to the present disclosure, the free connectors, fixed connectors, and/or couplers disclosed herein can be enhanced with a security feature achieved through a unique keying scheme. Referring to FIGS. 13-13D, a free connector 1300 with keying features is illustrated. Notably, without the keying features, the free connector 1300 has a forward face 1302 (e.g., forward face of free connector in FIG. 6) having a standardized outer perimeter, however, the illustrated free connector 1300 includes keying features that extend beyond the standardized perimeter.

More specifically, the free connector 1300 illustrates three possible keying features including a lower left downward extension 1310 comprising keying feature A, a lower right downward extension 1312 comprising keying feature B, and an upper right outward side extension 1314 comprising keying feature C. In certain embodiments, a greater or fewer number of keying features can be used to generate different keying feature combinations. For reference, FIG. 13C shows a standardized perimeter SP defined by the forward face of the free connector in FIG. 6 overlayed onto the forward face of the free connector 1300. In this view, it can be readily observed that keying features A, B, C/extensions 1310, 1312, 1314 extend outwardly beyond the standardized outer perimeter SP in a direction away from the central cavity 1301 of the fixed connector/coupler 1350 in which the free connector 1300 is inserted. In the example shown, the standardized perimeter SP defined by the free connector shown at FIG. 6 and that is illustrated at FIG. 13C is in conformance with IEC (International Electrochemical Committee) standard IEC 63171-1.

FIG. 13 additionally illustrates a forward face of a fixed connector or coupler 1350 (e.g., either the fixed connector or the coupler can incorporate the illustrated keying features: the coupler can incorporate the keying features in both the first and second ends) incorporating recessed keying features to accommodate the extensions found on the free connector 1300. Corresponding to the modification of the outer perimeter of the forward face of the free connector 1300, the inner perimeter of the opening of the fixed connector/coupler 1350 is modified to accommodate the keying features. As shown, the fixed connector/coupler 1350 includes a lower right recess 1360 comprising corresponding keying feature A, a lower left recess 1362 comprising corresponding keying feature B, and an upper left side recess 1364 comprising corresponding keying feature C. The fixed connector/coupler 1350 is also shown as incorporating a keying feature 1366 that is used to prevent the insertion of LC fiber optic connectors, which are similarly sized to the free connector 1300, into the fixed connector/receptacle 1350. The keying feature 1366 is an inwardly extending protrusion that extends in a direction towards the central cavity 1301 of the fixed connector 1300. In one aspect, the keying feature 1366 is oriented and sized to be received by a respective recess or notch 1317 defined in the free connector 1300. Notably, the recess or notch 1317 is part of the standardized perimeter SP defined by IEC 63171-1.

Table 1 of FIG. 13 illustrates at least seven, e.g., Key 1 through Key 7, possible unique combinations of the A, B, and C keying features that a user may make distinctly their own to establish a secure, keyed network configuration. Further security enhancements can be provided through unique color coding, e.g., only a red free connector with key type of Key 1 is to be used with a red fixed connector/coupler with key type of Key 1.

Note that free connector 1300 also includes a stabilizing feature 1316 that is included in each keyed configuration. The stabilizing feature 1316 includes a slightly recessed upper left side edge that interfaces with a corresponding stabilizing feature 1368 of the fixed connector/coupler 1350. The stabilizing feature 1368 is a slightly projected channel on the interior right-side wall of the fixed connector/coupler 1350 (as viewed at FIG. 13A) which is an inwardly directed protrusion extending towards the cavity 1301. The combined stabilizing features of the free connector 1300 and the fixed connector 1350 prevent the keyed free connector 1300 from wobbling within the fixed connector due to uneven keying features (e.g., a free connector 1300 having keying feature A, extension 1310 without having keying feature B, extension 1312). In one aspect, the stabilizing feature 1368 of the fixed connector 1350 extends inwardly through the standardized perimeter SP. As such, the stabilizing feature 1368 prevents the insertion of a free connector having the standardized perimeter SP, for example a standardized perimeter conforming to IEC 63171-1 such as is shown at FIG. 6.

In one aspect, the standardized perimeter SP can be characterized as a main outer perimeter of the free connector 1300, wherein the keying features A, B, C/extensions 1310, 1312, 1314 extend outwardly beyond the main outer perimeter, wherein the recess 1317 extends inwardly from the main outer perimeter, and wherein the stabilizing feature 1316 is located within the main outer perimeter.

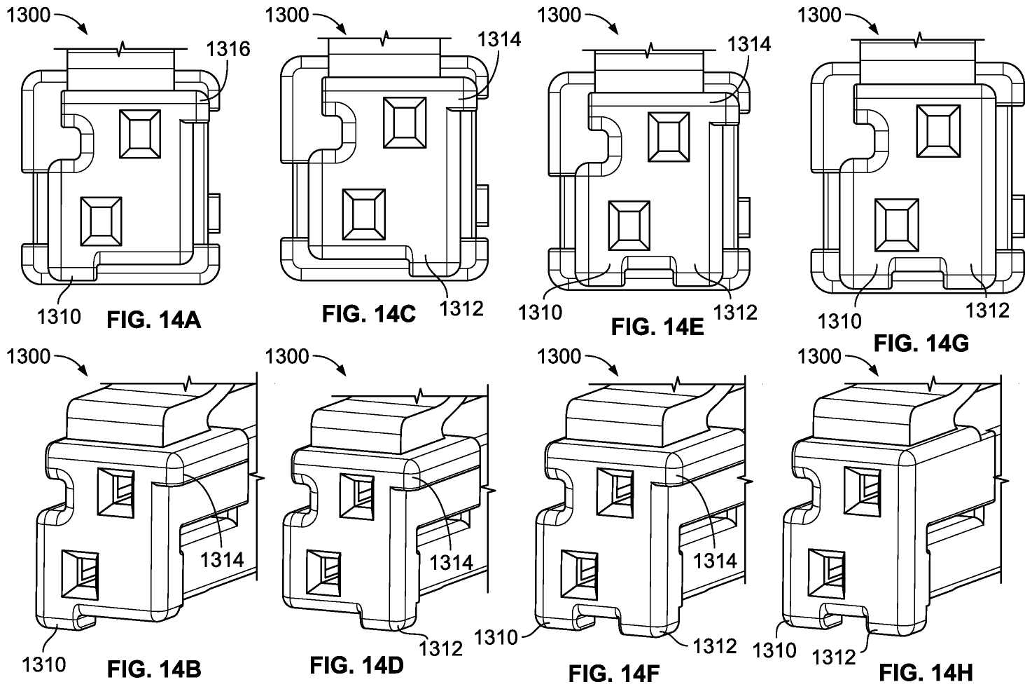

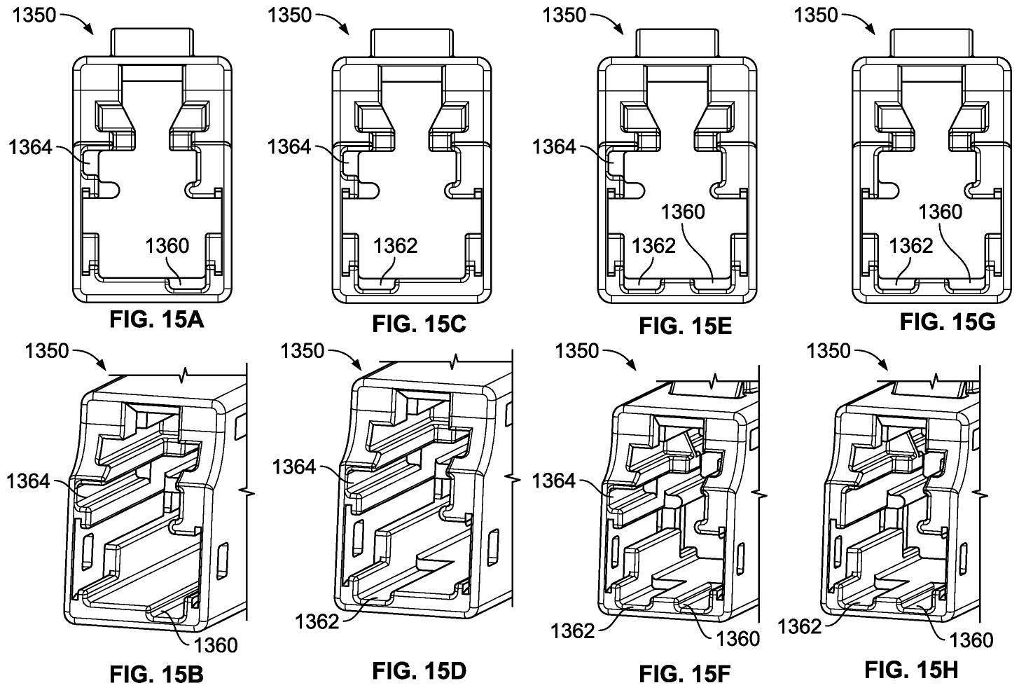

FIGS. 14A-14H illustrate the free connector 1300 in the first four key type configurations listed in Table 1 of FIG. 13, while FIGS. 15A-15H illustrate the corresponding mating fixed connector/coupler 1350 in the first four key type configurations listed in Table 1. Accordingly, FIGS. 14A-14B and FIGS. 15A-15B are associated with key type Key 1, FIGS. 14C-14D and FIGS. 15C-15D are associated with key type Key 2, FIGS. 14E-14F and FIGS. 15E-15F are associated with key type Key 3, and FIGS. 14G-14H and FIGS. 15G-15H are associated with key type Key 4. It is noted that Table 1 additionally discloses key types Key 5, Key 6, and Key 7 which include different combinations of the disclosed key features not shown in the drawings but readily understandable to a person having skill in the art based on the teachings of the present disclosure.

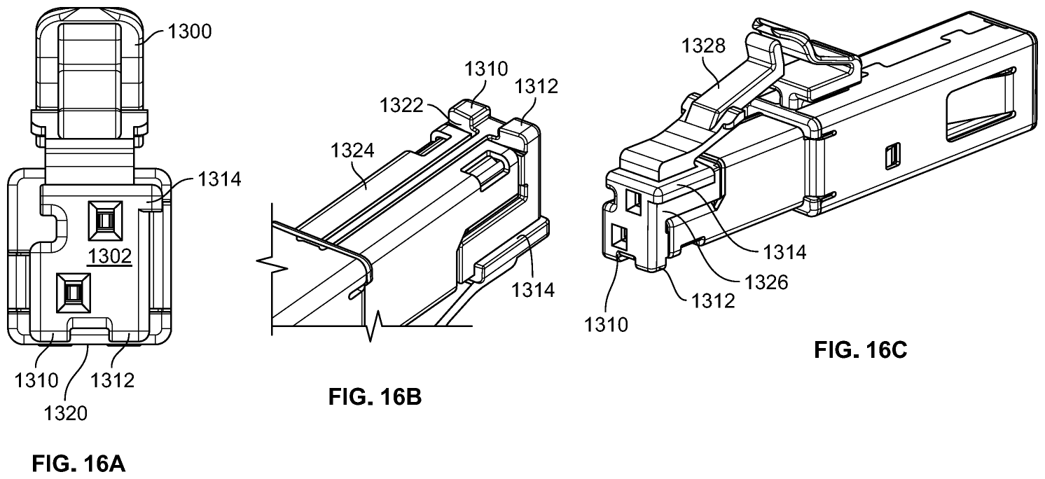

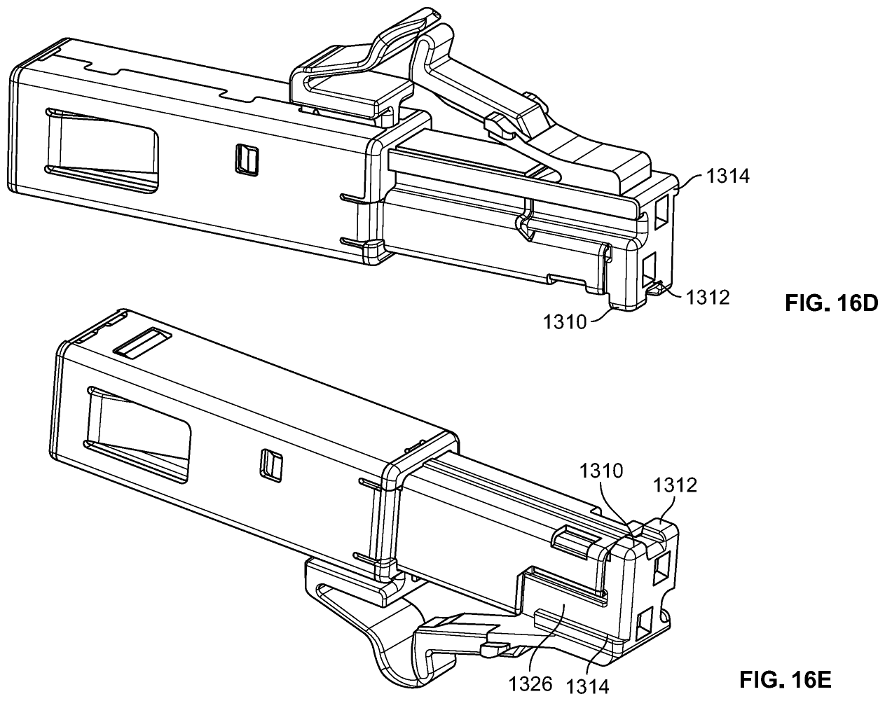

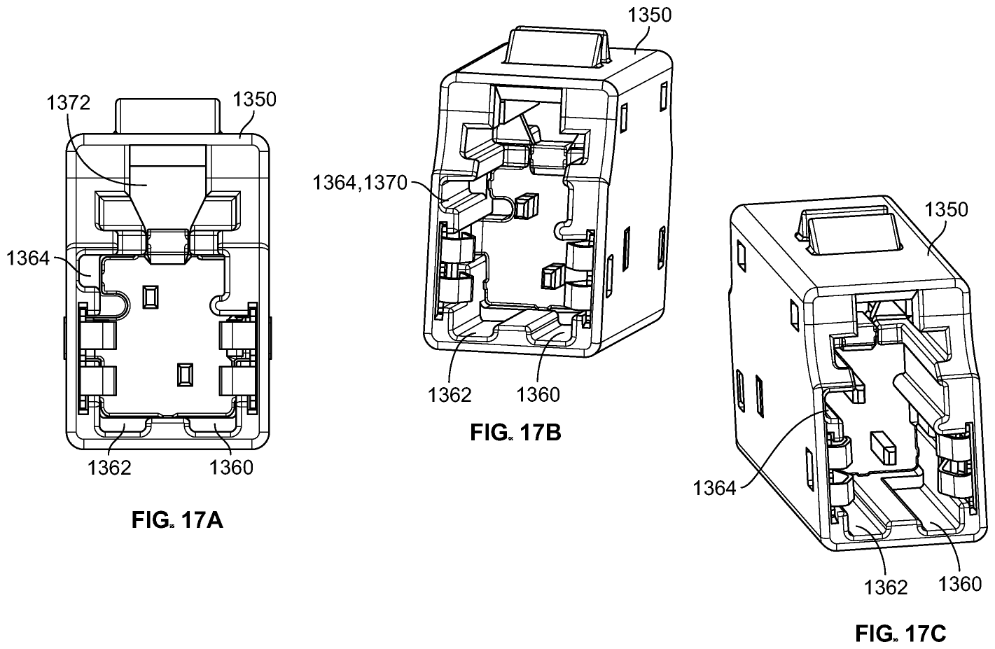

FIGS. 16A-16E illustrate the free connector 1300 having key type Key 3, e.g., all keying features 1310, 1312, and 1314 are present in the embodiment. The various drawing views enable appreciation of the height, width and depth of the three keying features. For example, keying features 1310, 1312 extend downward from the forward face of the free connector 1300 but do not extend past a lowest bottom edge 1320 of the overall free connector 1300. Further, the depth of keying features 1310, 1312 extend from the forward face of the free connector to a forwardmost edge 1322 of a metal frame 1324 of the free connector 1300. Keying feature 1314 extends along a side face 1326 of the free connector 1300. The length of the keying feature 1314 is supported by a channel 1370 within the fixed connector/coupler 1350 helping to provide stability to the free connector 1300 when inserted in the fixed connector/coupler 1350, see FIGS. 17A-17C: the securing of a latch 1328 of the free connector 1300 within a notch 1372 of the fixed connector/coupler 1350 also helps to provide stability to the free connector when inserted in the fixed connector 1350.

It will be appreciated that aspects of the above embodiments may be combined in any way to provide numerous additional embodiments. These embodiments will not be described individually for the sake of brevity.

While the present invention has been described above primarily with reference to the accompanying drawings, it will be appreciated that the invention is not limited to the illustrated embodiments: rather, these embodiments are intended to disclose the invention to those skilled in this art. Note that features of one or more embodiments can be incorporated in other embodiments without departing from the spirit of the invention. In the drawings, like numbers refer to like elements throughout. Thicknesses and dimensions of some components may be exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Herein, the terms “attached”, “connected”, “interconnected”, “contacting”, “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A security connector, comprising:
a free connector housing exactly two contacts that conduct data and/or power, the free connector having a front face defining a main outer perimeter and including at least one recess extending inwardly from the main outer perimeter and including at least one keying extension extending outwardly from the main outer perimeter.

2. The security connector of claim 1, wherein up to three different keying extensions extend outward from the main outer perimeter.

3. The security connector of claim 2, wherein the up to three different keying extensions provide at least seven different keying combinations.

4. The security connector of claim 3, wherein the free connector additionally includes a color-coded security feature.

5. The security connector of claim 2, wherein the up to three different keying extensions comprise at least one of a downward extension and a side extension.

6. The security connector of claim 2, wherein the up to three different keying extensions consist of a first downward extension, a second downward extension, and a side extension.

7. The security connector of claim 1, further including a stabilizing feature located within the main outer perimeter.

8. A security connector comprising:
a forward connector body, housing exactly two electrical contacts that transmit data, power, or both data and power, the forward connector body including a forward portion and a rearward portion, the forward portion having a forward face with a main outer perimeter and at least one keying extension extending outward from the main outer perimeter;
a rear connector body that interfaces with the forward connector body, the rear connector body defining a central channel to receive a single pair conductors that electrically interface with the exactly two electrical contacts; and
a metal frame having a rearward portion and forward portion, the rearward portion of the metal frame positioned about the rear connector body and a rearward portion of the forward connector body, the forward portion of the metal frame positioned about the forward portion of the forward connector body.

9. The security connector of claim 8, wherein up to three different keying extensions extend outward from the main outer perimeter.

10. The security connector of claim 9, wherein the up to three different keying extensions provide at least seven different keying combinations.

11. The security connector of claim 10, wherein the forward connector body additionally includes a color-coded security feature.

12. The security connector of claim 9, wherein the up to three different keying extensions comprise at least one of a downward extension and a side extension.

13. The security connector of claim 9, wherein the up to three different keying extensions consist of a first downward extension, a second downward extension, and a side extension.

14. The security connector of claim 8, wherein the at least one keying extension extends downward from the forward face and has a depth that extends to a forward edge of the metal frame.

15. The security connector of claim 8, wherein the exactly two electrical contacts each have first ends that comprise a tuning fork contact and each have second ends that comprise insulation displacement contacts (IDCs).

16. The security connector of claim 8, wherein the forward connector body includes a stabilizing feature located within the main outer perimeter.

17. A coupler comprising:
a dual-ended coupler body housing a contact sub-assembly having exactly two electrical contacts that transmit both power and data, at least one end of the dual-ended coupler body including at least one keying recess corresponding to the at least one keying extension of the security connector of claim 1, enabling the security connector to interface with the dual-ended coupler body.

18. A fixed connector comprising:
a connector body housing exactly two electrical contacts that transmit both power and data, the connector body including an opening for receiving the security connector of claim 1, the opening of the connector body including at least one keying recess corresponding to the at least one keying extension of the security connector.

19. A multi-way coupler comprising:
a coupler body having at least three openings, each opening for receiving a free connector having exactly two contacts for transmitting both power and data, at least one of the three openings of the coupler body including at least one keying recess corresponding to the at least one keying extension of the security connector of claim 1, enabling the security connector to interface with the coupler body.

20. A security connector, comprising:
a free connector housing exactly two contacts that conduct data and/or power, the free connector having a front face defining a main outer perimeter and including at least one recess extending inwardly from the main outer perimeter and including at least one keying extension extending outwardly from the main outer perimeter, wherein the main outer perimeter is defined by International Electrochemical Committee Standard IEC 63171-1.
